(19) United States
(12) Patent Application Publication
(10) Pub. No.: US 2009/0023011 A1
(43) Pub. Date: Jan. 22, 2009

(54) Systems and Methods for Forming Conductive Traces on Plastic Substrates

(75) Inventors: Sterling Chaffins, Albany, OR (US); Kevin P. DeKam, Albany, OR (US); Craig A. Tress, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Fort Collins, CO (US)

(21) Appl. No.: 11/780,646

(22) Filed: Jul. 20, 2007

(51) Int. Cl. B32B 33/00; C23C 28/00

(52) U.S. Cl. 428/656; 427/97.3; 428/646; 428/686

(57) ABSTRACT

Systems and methods for forming conductive traces on plastic substrates. In one embodiment, conductive traces are formed by forming a polyelectrolyte layer on a polymeric substrate and growing conductive traces on the polyelectrolyte layer using an electroless plating process.

### BACKGROUND

In certain situations, it is desirable to form conductive traces, such as those of a circuit, on plastic substrates. In some current techniques, such traces are separately formed on a conductive substrate using an electrolytic plating process, and then the traces are transferred from the conductive substrate to a plastic substrate.

Use of electrolytic plating processes can be considered disadvantageous because they require the use of circuitry to drive the reaction that causes the growth of the traces. In addition, it can be difficult to successfully transfer the formed traces to a plastic substrate.

### BRIEF DESCRIPTION OF THE DRAWINGS

The disclosed systems and methods can be better understood with reference to the following drawings. The components in the drawings are not necessarily to scale.

FIG. 1 is flow diagram of an embodiment of a method for fabricating conductive traces on a plastic substrate.

FIGS. 2A-2G are schematic views illustrating steps performed in the method described in relation to FIG. 1.

FIG. 3 is a photograph of a conductive trace formed using the method described in relation to FIG. 1.

### DETAILED DESCRIPTION

As described above, conductive traces are typically provided on plastic substrates by separately forming the traces on a conductive substrate using an electrolytic plating process and then transferring the traces to the plastic substrate. Such a process requires the use of circuitry to drive the reaction that causes the growth of the traces and it can be difficult to successfully transfer the formed traces to the plastic substrate. As described below, however, such traces can be directly formed on a plastic substrate using an electroless plating process. In some embodiments, a polyelectrolyte layer is formed on the plastic substrate and enables the growth of conductive traces on the substrate.

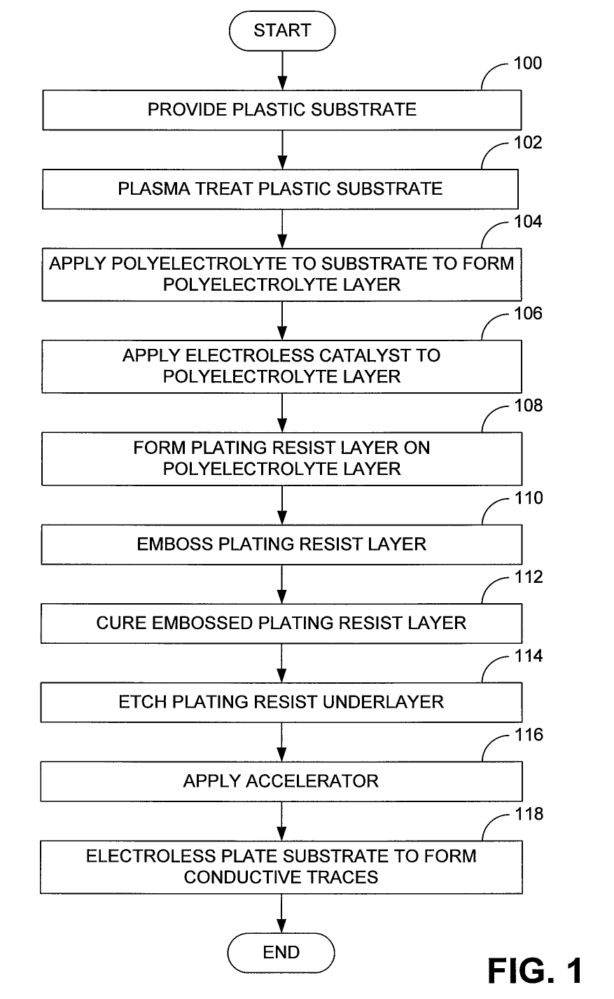

FIG. 1 describes an example method for fabricating traces on a plastic substrate. In some embodiments, the traces form a circuit on the plastic substrate. Such a circuit may be generally referred to as a “plastic circuit” for convenience. Therefore, the method described in relation to claim 1 may also be referred to as a method for fabricating or forming a plastic circuit.

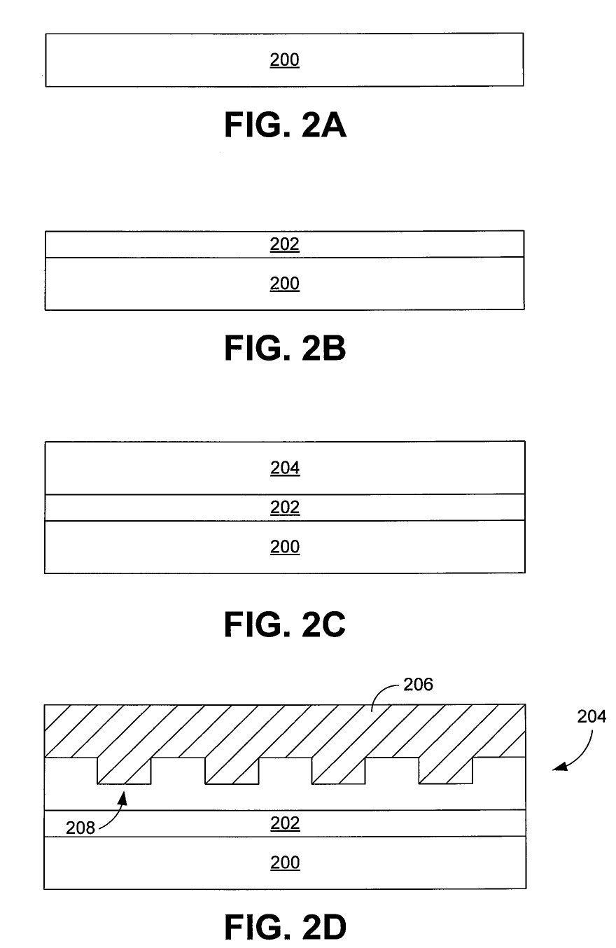

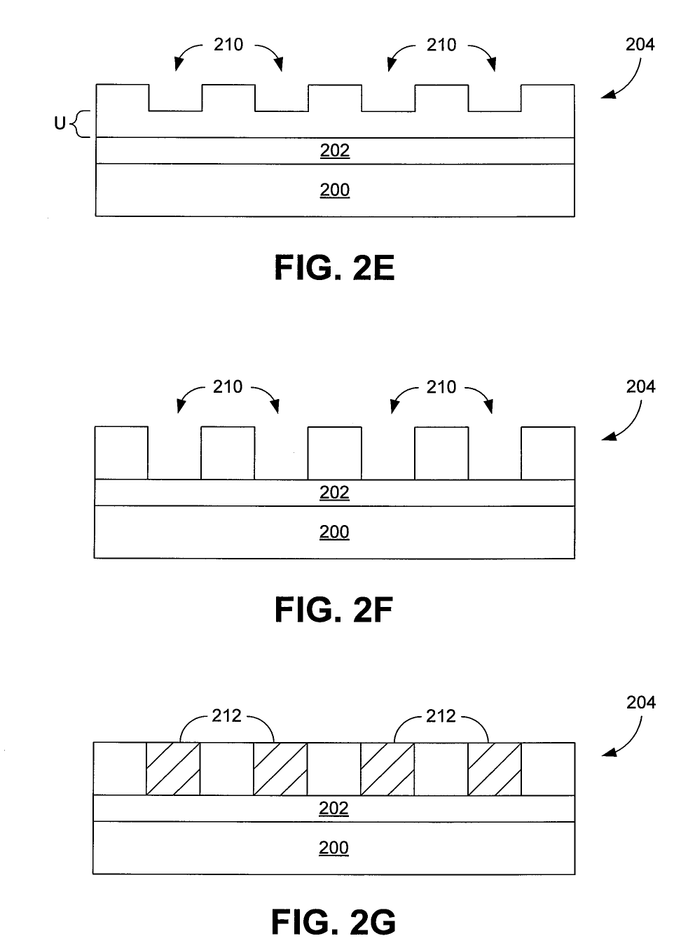

Beginning with block 100 of FIG. 1, a plastic substrate is provided. FIG. 2A illustrates an example of such a substrate 200. The substrate 200 can be formed of substantially any polymeric material. Therefore, the substrate 200 can also be referred to as a polymeric substrate. By way of example, the substrate 200 is formed of polyethylene terephthalate (PET), polyethylene naphthalate (PEN), polyethersulfone (PES), cycloaliphatic polymer (e.g., ZF16 from Zeon Chemicals), acrylic, polycarbonate, mylar, or the like. The thickness of the substrate 200 depends upon the desired application. In some embodiments, the substrate 200 is approximately 0.05 to 0.2 millimeters (mm) thick.

With reference to block 102 of FIG. 1, the substrate is plasma treated. In some embodiments, the substrate is oxygen plasma treated to create a negative charge on the substrate. Once the plasma treatment has been performed, polyelectrolyte material is applied to the substrate to form a polyelectrolyte layer, as indicated in block 104. As described below, the polyelectrolyte layer both facilitates the growth of conductive traces and provides for adhesion of the traces to the substrate. FIG. 2B illustrates an example polyelectrolyte layer 202 formed on the substrate 200.

In some embodiments, positively charged and negatively charged polyelectrolytes are alternately applied to the substrate using a dunk process in which the substrate is immersed in a polyelectrolyte solution for a predetermined period of time and the excess polyelectrolyte is rinsed from the substrate. Although such alternate application of polyelectrolyte may result in alternating discrete layers of positively charged and negatively charged polyelectrolyte being formed, discrete layers may not form in all cases. Positively charged and negatively charged polymer chains may instead form on the substrate in a random manner to form a homogeneous polyelectrolyte layer. In some embodiments, the nature of the polyelectrolyte layer and whether alternating discrete layers are formed depends upon whether the polyelectrolytes are strongly or weakly charged.

Examples of strong positively charged polyelectrolytes include polyacrylamido-N-propyltrimethylammonium chloride (PAPTAC) and materials having trimethylammonium groups. Examples of weak positively charged polyelectrolytes include polyallylaminehydrochloride (PAH), polyethylene amine, and materials having amine groups. Examples of strong negatively charged polyelectrolytes include polystyrenesulfonic acid (PSS) and materials having sulfonic or phosphonic acid groups. Examples of weak negatively charged polyelectrolytes include polyacrylic acid (PAA) and materials having carboxylic acid groups.

The thickness of the polyelectrolyte layer depends upon the desired application and may depend upon the number of times polyelectrolyte is applied to the substrate. In some embodiments, 5 to 10 such applications are performed, resulting in a polyelectrolyte layer that is approximately 1 to 100 nanometers (nm) thick.

Next, with reference to block 106 of FIG. 1, an electroless catalyst is applied to the polyelectrolyte layer. In some embodiments, the catalyst is absorbed into the polyelectrolyte layer. As described below, the catalyst is used to initiate the growth of the conductor traces. In some embodiments, the catalyst is applied using a dunk process in which the substrate and its polyelectrolyte layer are immersed in an electroless catalyst solution. In other embodiments, the catalyst is applied using a spray process in which the polyelectrolyte layer is sprayed with an electroless catalyst solution. By way of example, the electroless catalyst solution comprises palladium particles (e.g., nanoparticles) suspended in an acidic aqueous solution. In addition to palladium, suitable electroless catalysts include particles of copper, nickel, silver, tin, gold, or other conductive metals. Notably, salts of those metals that can be reduced by a reducing agent to form the metal can also be used. The reducing agent may be chemically, electrochemically, or photochemically activated to generate a metal catalyst. Examples of reducing agents include boranes. In alternative embodiments, metal particles having a protective coating can be used. In such cases, reduction comprises removal of the protective coating. One example of such metal particle includes palladium nanoparticles coated with zinc. In such a case, an acid, such as hydrochloric acid, can be used to remove the zinc to expose the palladium metal.

Referring now to block 108 of FIG. 1, a plating resist layer is formed on the polyelectrolyte layer. FIG. 2C illustrates an example of such a plating resist layer 204 formed on the polyelectrolyte layer 202. In some embodiments, the plating resist layer is formed of a resin. However, any non-conductive resist material could be used, such as ceramics, sol-gels, metal oxides, or other non-conductive materials that can be patterned. Given that the thickness of the plating resist layer 204 generally dictates the thickness or height of the conductive traces that will be formed (described below), the thickness of the plating resist layer can be selected to provide the desired conductive trace dimensions. In some embodiments, the plating resist layer 204 is approximately 0.1 to 10 μm thick. In other embodiments, the plating resist layer 204 is approximately 1 to 5 μm thick.

With reference back to FIG. 1, the plating resist layer 204 can then be patterned. In one technique, the plating resist layer 204 is embossed, as indicated in block 110. FIG. 2D illustrates an example of the embossing process. As indicated in FIG. 2D, the plating resist layer 204 is embossed with an embossing stamp 206 that comprises a pattern of three-dimensional features 208 that displace the material of the plating resist layer to define the layout of the various conductive traces that will be formed. Once the stamp has been applied, the plating resist layer is cured, as indicated in block 112 of FIG. 1.

After curing, the embossing stamp is removed. Referring to FIG. 2E, a plating resist layer 204 having a plurality of trenches 210 results. The bottom surfaces of the trenches 210 generally define an underlayer, which is generally identified in FIG. 2E by reference letter U. The underlayer must be removed from the trenches at this point so that plating material can reach the polyelectrolyte layer 202. Therefore, as indicated in block 114 of FIG. 1, the plating resist underlayer is etched. By way of example, the underlayer is removed from the trenches using an oxygen plasma etch, an oxygen etch, an oxygen and tetrafluoromethane etch, a tetrafluoromethane etch, an oxygen, argon, and tetrafluoromethane etch, or a sulfur hexafluoride etch. Other etching methods may be used, however, such as an acid or a base etch. Suitable acid etches include combinations of hydrochloric acid, sulfuric acid, nitric acid, peroxide solutions, phosphoric acid, acetic acid. Suitable base etches include sodium hydroxide and potassium hydroxide. As indicated in FIG. 2F, the result of such etching are trenches 210 that extend from the surface of the plating resist layer 204 down to the polyelectrolyte layer 202. In performing the etching, care is taken so as not to destroy the polyelectrolyte layer 202 at the trenches 210. Such destruction can possibly be avoided with knowledge of and control over the etch rate, etch time, and underlayer thickness.

In cases in which a layer of material, such as an oxide, is to be removed from the electroless catalyst contained within the polyelectrolyte layer, an accelerator is applied to the substrate, as indicated in block 116 of FIG. 1. For example, if palladium nanoparticles have been used that are coated with zinc, an accelerator may be necessary to remove the zinc and any zinc oxide that may have formed during previous fabrication steps. In some embodiments, the accelerator is applied using a dunk process in which the substrate is immersed in an acid solution such as hydrochloric acid, or a wet etch solution, such as those described above.

At this point, the substrate is prepared for plating. Therefore, as indicated in block 118 of FIG. 1, the substrate is electrolessly plated to form the conductive traces. In that process, plating material begins to form at the bottom of the trenches due to the presence of the electroless catalyst within the polyelectrolyte layer. The plating material then builds with the trenches to form the traces. As indicated in FIG. 2G, conductive traces 212 result that extend from the polyelectrolyte layer 202 to the top surface of the plating resist layer 204. Notably, the portions of the plating resist layer 204 that remain after trench formation are left in tact so that they may serve as insulators for the various traces 212.

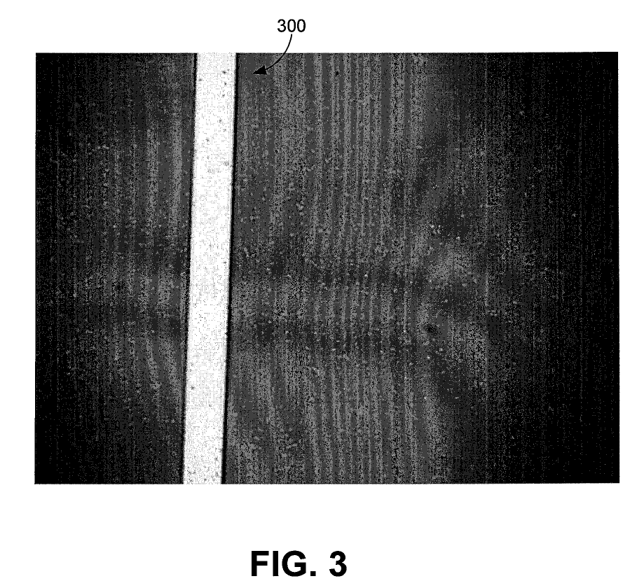

FIG. 3 is a photograph of a single conductive trace 300 formed using the process described in the foregoing. Specifically, shown is a 10 micron (μm) wide trace at 100× magnification. As is apparent from FIG. 3, well-defined, precise traces can be formed using the disclosed methods.

What is claimed is:

1. A method for forming conductive traces, the method comprising:
providing a polymeric substrate;
forming a polyelectrolyte layer on the polymeric substrate; and
growing conductive traces on the polyelectrolyte layer using an electroless plating process.

2. The method of claim 1, wherein the polymeric substrate is comprises a material selected from the group comprising polyethylene terephthalate (PET), polyethylene naphthalate (PEN), polyethersulfone (PES), cycloaliphatic polymer, acrylic, polycarbonate, and mylar.

3. The method of claim 1, wherein the polyelectrolyte layer comprises a polyelectrolyte selected from the group comprising polyacrylamido-N-propyltrimethylammonium chloride (PAPTAC), materials having trimethylammonium groups, polyallylaminehydrochloride (PAH), polyethylene amine, materials having amine groups, polystyrenesulfonic acid (PSS), materials having sulfonic or phosphonic acid groups, polyacrylic acid (PAA), and materials having carboxylic acid groups.

4. The method of claim 1, wherein forming a polyelectrolyte layer comprises alternately applying positively charged and negatively charged polyelectrolyte to the polymeric substrate.

5. The method of claim 4, further comprising creating a charge on the polymeric substrate prior to forming the polyelectrolyte layer and wherein alternately applying positively charged and negatively charged polyelectrolyte comprises first applying positively charged electrolyte to the polymeric substrate.

6. The method of claim 5, wherein creating a charge on the polymeric substrate comprises plasma treating the polymeric substrate.

7. The method of claim 1, further comprising applying an electroless catalyst to the polyelectrolyte layer prior to growing conductive traces.

8. The method of claim 7, wherein the electroless catalyst comprises a material selected from the group comprising palladium, copper, nickel, silver, tin, gold, and salts thereof.

9. The method of claim 1, further comprising forming a layer of plating resist layer on the polyelectrolyte layer and forming trenches in the plating resist layer in which the conductive traces are grown.

10. The method of claim 9, wherein forming trenches in the plating resist layer comprises embossing the plating resist layer with a stamp and curing the plating resist layer.

11. The method of claim 10, wherein forming trenches further comprises etching a pattern formed in the plating resist layer by the stamp so that the trenches extend from a top surface of the plating resist layer to the polyelectrolyte layer.

12. The method of claim 1, wherein the conductive traces comprise metal traces.

13. A method for forming conductive traces on a polymeric substrate, the method comprising:
creating a charge on the polymeric substrate;
alternately applying positively charged and negatively charged polyelectrolyte to the polymeric substrate to form a polyelectrolyte layer on the polymeric substrate;
applying an electroless catalyst to the polyelectrolyte layer;
forming a plating resist layer on the polyelectrolyte layer;
forming trenches in the plating resist layer that extend down to the polyelectrolyte layer; and
growing conductive traces within the trenches using an electroless plating process.

14. The method of claim 13, wherein the positively charged polyelectrolyte is selected from the group comprising polyacrylamido-N-propyltrimethylammonium chloride (PAPTAC), materials having trimethylammonium groups, polyallylaminehydrochloride (PAH), polyethylene amine, and materials having amine groups.

15. The method of claim 13, wherein the negatively charged polyelectrolyte is selected from the group comprising polystyrenesulfonic acid (PSS), materials having sulfonic or phosphonic acid groups, polyacrylic acid (PAA), and materials having carboxylic acid groups.

16. The method of claim 13, wherein the electroless catalyst is selected from the group comprising palladium, copper nickel, silver, tin, gold, and salts thereof.

17. The method of claim 13, wherein the plating resist layer comprises a material that is selected from the group comprising resin, ceramics, sol-gels, and metal oxides.

18. The method of claim 13, wherein forming trenches comprises embossing the plating resist layer and etching an underlayer of the plating resist layer.

19. The method of claim 13, wherein the conductive traces comprise metal traces.

20. A plastic circuit comprising:
a polymeric substrate;
a polyelectrolyte layer formed on the polymeric substrate; and
conductive traces formed on the polyelectrolyte layer.

21. The circuit of claim 20, wherein the polymeric substrate comprises a material selected from the group comprising polyethylene terephthalate (PET), polyethylene naphthalate (PEN), polyethersulfone (PES), cycloaliphatic polymer, acrylic, polycarbonate, and mylar.

22. The circuit of claim 20, wherein the polyelectrolyte layer comprises a polyelectrolyte selected from the group comprising polyacrylamido-N-propyltrimethylammonium chloride (PAPTAC), materials having trimethylammonium groups, polyallylaminehydrochloride (PAH), polyethylene amine, materials having amine groups, polystyrenesulfonic acid (PSS), materials having sulfonic or phosphonic acid groups, polyacrylic acid (PAA), and materials having carboxylic acid groups.

23. The circuit of claim 22, wherein the polyelectrolyte layer comprises an electroless catalyst.

24. The circuit of claim 23, wherein the electroless catalyst comprises a material selected from the group comprising palladium, copper nickel, silver, tin, gold, and salts thereof.

25. The circuit of claim 23, further comprising a plating resist layer formed on the polyelectrolyte layer, the plating resist layer including a plurality of trenches, wherein the conductive traces are provided within the trenches.
